(19) United States
(12) Patent Application Publication
(10) Pub. No.: US 2003/0062120 A1
(43) Pub. Date: Apr. 3, 2003

(54) Method of side panel tucking

(76) Inventors: David Michael Lehner, Appleton, WI (US); Kent Allan Franklin, Appleton, WI (US); Jack Lee Couillard, Menasha, WI (US); Scott Gerald Chapple, Neenah, WI (US)

Correspondence Address: Pauley Petersen Kinne & Fejer, Suite 365, 2800 W. Higgins Road, Hoffman Estates, IL, 60195, US

(21) Appl. No.: 09/966,795

(22) Filed: Sep. 28, 2001

(51) Int. Cl. B29C 65/00

(52) U.S. Cl. 156/285; 156/227

(57) ABSTRACT

A method of tucking a pair of side panels into a body portion of a pant-like garment in which the tucking distance can be controlled. The garment is positioned between a pair of consecutive stacker finger units. Vacuum applied through fingers on the stacker finger units holds the garment in place. A distance between the pair of stacker finger units is increased to open the garment. While the garment is in an open position, either a mechanical device or fluid streams can be used to tuck the side panels into the body portion of the garment.

### BACKGROUND OF THE INVENTION

This invention is directed to a method of tucking side panels into a main body of a pant-like garment.

Pant-like garments, such as disposable training pants, as well as adult incontinence wear, infant and children's diapers, and swimwear, are typically folded into a compact configuration prior to packaging. The folded configuration typically includes folding the garment in half such that a front waist edge is aligned with and adjacent a back waist edge. For an even tidier appearance, and for manageability in manufacturing and packaging processes, the side panels or side portions of the garment can be tucked in between a front panel and a back panel of the garment.

Certain automated processes exist in which the side panels are mechanically tucked into the garments along a conveyor prior to the garments reaching an accumulation device, such as a stacker assembly. In such processes, as the garment is being conveyed towards the stacker assembly, mechanical blades rotate in the product machine direction and push the side panels in from each side of the conveyor and overlap in the middle of the pant-like garment. When the side panels are tucked in this manner, the waist elastic material is tucked, as well, since there is no dimension set as to the depth of the side panel tuck.

Heat-activated elastomeric material is often used to form waist bands and to add elasticity to side panels. The heat-activated elastomeric material is typically applied to the garment in an unactivated state, and is subsequently activated. The activated elastic can be difficult to handle due to the elastic's tendency to gather the substrate to which the elastic is applied. One technique of handling garments with heat-activated elastomeric material involves folding or tucking the garment into a pre-selected orientation and holding the garment in that orientation while heat activating the elastic. However, if the waist band material or any other heat-activated material is tucked into the garment, or otherwise folded, while the elastic is being heat-activated, the heat-activated material will be inconsistently heated, thus inconsistently activated, resulting in an inconsistent fit.

Another drawback to using conventional side panel tucking methods is that the side panels are typically tucked completely inside the garment, thereby obscuring the consumer's view of the side panels prior to purchasing the garment. Pant-like garments, such as swimwear, are sometimes produced with side panels of a different color than the body portions of the garments to enhance the appearance of the garments, thus creating greater consumer appeal. When the side panels are tucked completely inside the garment, only the body portion of the garment is visible to the consumer.

There is a need or desire for a method of tucking side panels in which the degree, or depth, of tucking can be controlled.

### SUMMARY OF THE INVENTION

In response to the discussed difficulties and problems encountered in the prior art, a new method of tucking side panels has been discovered.

The present invention is directed to a method of tucking a pair of opposing side panels into a body portion of a pant-like garment in which the depth of the tuck can be controlled. The method involves the steps of inserting a folded pant-like garment between consecutive split fingers of an accumulation device, such as a stacker assembly. The stacker fingers are equipped with a vacuum delivery along both sides of the fingers to maintain the pant-like garment in place adjacent the fingers. As the pant-like garment is conveyed through the stacker assembly, consecutive stacker fingers move apart, thereby opening the pant-like garment. Once the garment is opened, the side panels can be tucked to a pre-determined degree, using either fluid streams or a mechanical device, such as a tucking assembly.

Suitable tucking assemblies for use in the present invention may include a driven array of paddles on a carrier, such as a chain, belt, or cable, or a rotating blade tucker, or a fixed plunge device activated hydraulically or pneumatically, or a timed air blast. The action of the tucking assembly unit or units is timed or registered with the movement of the stacker assembly in order to avoid collision or interference with movement of the stacker fingers.

The paddle/carrier configuration, for example, can include two separate sets of carriers and paddles, with each set located on opposing sides of the garment and rotating in opposite directions. Each set of carriers and paddles suitably has a pitch, i.e., spacing between paddles. The paddle pitch, in combination with the relative angle of the tucking assembly carrier to the carrier of the stacker assembly and the relative velocities of the two carrier assemblies, needs to be selected so that the effective pitch of the paddles closely matches the distance (pitch) between stacker finger units. Also, the effective velocity of the paddles in the overall direction of travel of the finger units must closely match the velocity of travel of the finger units in that direction. This arrangement prevents collisions.

In certain embodiments of the invention, cams can be used to guide the path of the carriers, or the path of the paddles which can be movable relative to the carrier.

The method of the invention can be carried out in one or more tucking steps. For example, if the pant-like garment includes heat-activatable elastomeric material, the garment can be partially tucked, then heat activated, then fully tucked. Alternatively, the garment can be heat activated in the open position and then fully tucked. By activating the elastomeric material prior to fully tucking the garment, the elastomeric material can be more consistently heat activated, thus resulting in a more consistent fit.

When multiple tucking steps are performed, each of the tucking steps can be carried out using either fluid streams or mechanical devices, as described above.

Because the depth of tucking can be controlled, the garment can be partially tucked, if desired. One benefit of partially tucking the side panels is that pant-like garments having side panels of a different color than the body portion can have the colors of both the side panels and the body portion made visible to consumers while in the package.

By tucking the side panels in a controlled manner as taught by the present invention, the garment has a finished look when in a packaged form.

With the foregoing in mind, it is a feature and advantage of the invention to provide a method of tucking side panels in which the degree, or depth, of tucking can be controlled.

### BRIEF DESCRIPTION OF THE DRAWINGS

FIG. 1 is a perspective view of a training pant suitable for use in the present invention;

FIG. 2 is a plan view of a stacker assembly;

FIG. 3 is a perspective view of two consecutive stacker finger units;

FIG. 4 is a perspective view of a partially tucked training pant positioned between consecutive stacker finger units;

FIG. 5 is a perspective view of a fully tucked training pant positioned between consecutive stacker finger units;

FIG. 6 is a plan view of one type of mechanical tucking device;

FIG. 7 is a perspective view of one type of paddle suitable for use with the mechanical tucking device of FIG. 6;

FIG. 8 is a perspective view of another type of paddle suitable for use with the mechanical tucking device of FIG. 6;

FIG. 9 is a plan view of another type of mechanical tucking device; and

FIG. 10 is a plan view of yet another type of mechanical tucking device.

### DEFINITIONS

Within the context of this specification, each term or phrase below will include the following meaning or meanings.

“Attached” refers to the joining, adhering, connecting, bonding, or the like, of at least two elements. Two elements will be considered to be attached to one another when they are attached directly to one another or indirectly to one another, such as when each is directly connected to intermediate elements.

“Bonded” refers to the joining, adhering, connecting, attaching, or the like, of at least two elements. Two elements will be considered to be bonded together when they are bonded directly to one another or indirectly to one another, such as when each is directly bonded to intermediate elements.

“Elastomeric” and “elastic” refer to that property of a material or composite by virtue of which it tends to recover its original size and shape after removal of a force causing a deformation. It is generally preferred that the elastomeric material or composite be capable of being elongated by at least 50 percent, more preferably by at least 300 percent, of its relaxed length and recover, upon release of an applied force, at least 50 percent of its elongation.

“Film” refers to a thermoplastic film made using a film extrusion process, such as a cast film or blown film extrusion process. The term includes apertured films, slit films, and other porous films which constitute liquid transfer films, as well as films which do not transfer liquid.

“Layer” when used in the singular can have the dual meaning of a single element or a plurality of elements.

“Liquid impermeable,” when used in describing a layer or multilayer laminate, means that a liquid, such as urine, will not pass through the layer or laminate, under ordinary use conditions, in a direction generally perpendicular to the plane of the layer or laminate at the point of liquid contact.

“Liquid permeable material” or “liquid water-permeable material” refers to a material present in one or more layers, such as a film, nonwoven fabric, or open-celled foam, which is porous, and which is water permeable due to the flow of water and other aqueous liquids through the pores. The pores in the film or foam, or spaces between fibers or filaments in a nonwoven web, are large enough and frequent enough to permit leakage and flow of liquid water through the material.

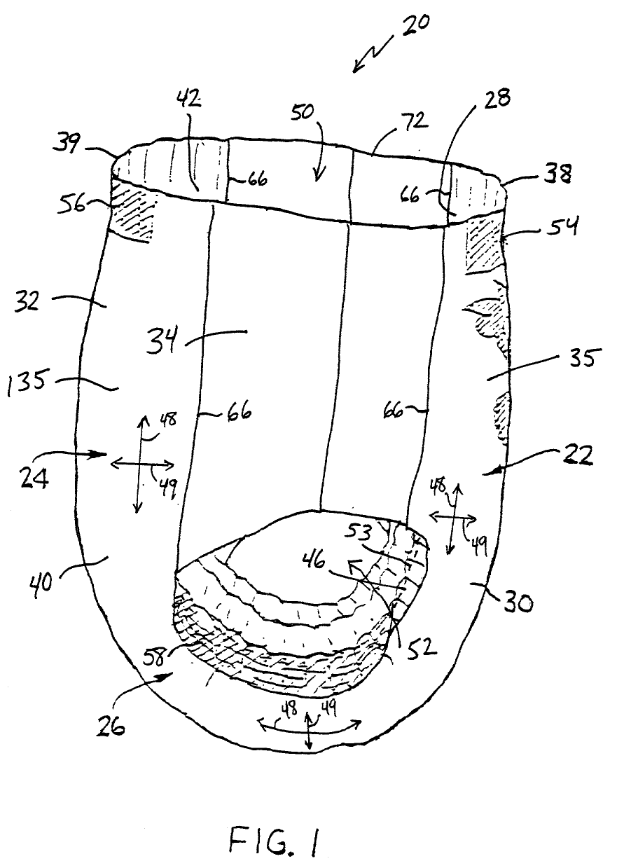

“Longitudinal” and “transverse” have their customary meaning, as indicated by the longitudinal and transverse axes depicted in FIG. 1. The longitudinal axis lies in the plane of the article and is generally parallel to a vertical plane that bisects a standing wearer into left and right body halves when the article is worn. The transverse axis lies in the plane of the article generally perpendicular to the longitudinal axis.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

“Member” when used in the singular can have the dual meaning of a single element or a plurality of elements.

“Nonwoven” and “nonwoven web” refer to materials and webs of material which are formed without the aid of a textile weaving or knitting process.

“Operatively joined,” in reference to the attachment of an elastic member to another element, means that the elastic member when attached to or connected to the element, or treated with heat or chemicals, by stretching, or the like, gives the element elastic properties; and with reference to the attachment of a non-elastic member to another element, means that the member and element can be attached in any suitable manner that permits or allows them to perform the intended or described function of the joinder. The joining, attaching, connecting or the like can be either directly, such as joining a member directly to an element, or can be indirectly by means of another member disposed between the first member and the first element.

“Pitch” refers to a repeated spacing between individual assembly elements, such as between consecutive paddles or consecutive split finger units.

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Refastenable” refers to the property of two elements being capable of releasable attachment, separation, and subsequent releasable reattachment without substantial permanent deformation or rupture. The refastenable elements can be attached, separated and reattached for at least one cycle, suitably for at least 5 cycles, or suitably for at least 10 cycles.

“Spunbonded fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Stretchable” means that a material can be stretched, without breaking, to at least 150% of its initial (unstretched) length in at least one direction, suitably to at least 250% of its initial length, desirably to at least 300% of its initial length.

“Superabsorbent” or “superabsorbent material” refers to a water-swellable, water-insoluble organic or inorganic material capable, under the most favorable conditions, of absorbing at least about 15 times its weight and, more desirably, at least about 30 times its weight in an aqueous solution containing 0.9 weight percent sodium chloride. The superabsorbent materials can be natural, synthetic and modified natural polymers and materials. In addition, the superabsorbent materials can be inorganic materials, such as silica gels, or organic compounds such as cross-linked polymers.

“Surface” includes any layer, film, woven, nonwoven, laminate, composite, or the like, whether pervious or impervious to air, gas, and/or liquids.

“Tucked” refers to a folded state of a garment in which at least one portion of the garment is inserted into the body portion to create a more compact orientation of the garment.

These terms may be defined with additional language in the remaining portions of the specification.

### DETAILED DESCRIPTION OF THE PRESENTLY PREFERRED EMBODIMENTS

The present invention is directed to a method of tucking a pair of side panels into a body portion of a pant-like garment. The method allows the degree, or depth, of tucking to be controlled. A detailed description of the tucking process follows a description of the garment below.

The principles of the present invention can be used with any suitable pant-like garment, such as training pants, diapers, incontinence products, other personal care or health care garments, including medical garments, or the like. As used herein, the term “incontinence products” includes absorbent underwear for children, absorbent garments for children or young adults with special needs such as autistic children or others with bladder/bowel control problems as a result of physical disabilities, as well as absorbent garments for incontinent older adults. For ease of explanation, the description hereafter will be in terms of a child's training pant.

Referring to FIG. 1, a training pant 20 is illustrated. The training pant 20 includes a pair of side panels 34, each extending from a waist opening 50 to one of two leg openings 52 on opposing sides of the pant 20. The side panels 34 can either be integrally formed with a body portion 32 of the pant 20, or can each include at least one separate element permanently attached to the body portion 32, as shown in FIG. 1. Furthermore, the side panels 34 can either be of a pull-on type, as shown in FIG. 1, or refastenable with refastenable seams extending from the waist opening 50 to one of the two leg openings 52 on opposing sides of the pant 20.

The body portion 32 defines a front region 22, a back region 24, a crotch region 26 interconnecting the front and back regions, an inner surface 28 which is configured to contact the wearer, and an outer surface 30 opposite the inner surface which is configured to contact the wearer's clothing. The body portion 32 also defines a pair of longitudinally opposed waist edges, which are designated front waist edge 38 and back waist edge 39. The front region 22 is contiguous with the front waist edge 38, and the back region 24 is contiguous with the back waist edge 39.

In the training pant 20 illustrated in FIG. 1, the front and back regions 22 and 24 are joined together to define a three-dimensional pant configuration having a waist opening 50 and a pair of leg openings 52. The front region 22 includes the portion of the training pant 20 which, when worn, is positioned on the front of the wearer while the back region 24 includes the portion of the training pant which, when worn, is positioned on the back of the wearer. The crotch region 26 of the training pant 20 includes the portion of the training pant which, when worn, is positioned between the legs of the wearer and covers the lower torso of the wearer.

The front region 22 of the body portion 32 includes a front panel 35 positioned between and interconnecting the side panels 34, along with a front waist elastic member 54 and any other connected components. The back region 24 of the body portion 32 includes a back panel 135 positioned between and interconnecting the side panels 34, as well as a rear waist elastic member 56 and any other connected components.

The body portion 32 is configured to contain and/or absorb any body exudates discharged from the wearer. For example, the body portion 32 desirably, although not necessarily, includes a pair of containment flaps 46 which are configured to provide a barrier to the transverse flow of body exudates. A flap elastic member 53 can be operatively joined with each containment flap 46 in any suitable manner as is well known in the art. The elasticized containment flaps 46 define an unattached edge which assumes an upright, generally perpendicular configuration in at least the crotch region 26 of the training pant 20 to form a seal against the wearer's body. The containment flaps 46 can extend longitudinally along the entire length of the body portion 32 or may only extend partially along the length of the body portion. Suitable constructions and arrangements for the containment flaps 46 are generally well known to those skilled in the art and are described in U.S. Pat. No. 4,704,116 issued Nov. 3, 1987 to Enloe, which is incorporated herein by reference.

The illustrated body portion 32 can include an outer cover 40, a bodyside liner 42 which is connected to the outer cover in a superposed relation, and an absorbent assembly (not shown) which is located between the outer cover 40 and the bodyside liner 42.

To further enhance containment and/or absorption of body exudates, the training pant 20 can include the front waist elastic member 54, the rear waist elastic member 56, and leg elastic members 58, as are known to those skilled in the art. The waist elastic members 54 and 56 can be operatively joined to the outer cover 40 and/or bodyside liner 42 along the opposite waist edges 38 and 39 as well as over waist edges 72 of the side panels 34, and can extend over part or all of the waist edges. The leg elastic members 58 can be operatively joined to the outer cover 40 and/or bodyside liner 42 while longitudinally aligned along the distal edges and positioned in the crotch region 26 of the body portion 32.

The flap elastic members 53, the waist elastic members 54 and 56, and the leg elastic members 58 can be formed of any suitable elastic material. As is well known to those skilled in the art, suitable elastic materials include sheets, strands or ribbons of natural rubber, synthetic rubber, or thermoplastic elastomeric polymers. The elastic materials can be stretched and adhered to a substrate, adhered to a gathered substrate, or adhered to a substrate and then elasticized or shrunk, for example with the application of heat; such that elastic constrictive forces are imparted to the substrate. In one particular embodiment, for example, the leg elastic members 58 include a plurality of dry-spun coalesced multifilament spandex elastomeric threads sold under the trade name LYCRA® and available from E. I. DuPont de Nemours and Company, Wilmington, Del., U.S.A.

The outer cover 40 desirably includes a material that is substantially liquid impermeable, and can be elastic, stretchable or nonstretchable. The outer cover 40 can be a single layer of liquid impermeable material, but desirably includes a multi-layered laminate structure in which at least one of the layers is liquid impermeable. For instance, the outer cover 40 can include a liquid permeable outer layer and a liquid impermeable inner layer that are suitably joined together thermally, ultrasonically, by a laminate adhesive, or by any other suitable methods known in the art. Suitable laminate adhesives, which can be applied continuously or intermittently as beads, a spray, parallel swirls, or the like, can be obtained from Findley Adhesives, Inc., of Wauwatosa, Wis., U.S.A., or from National Starch and Chemical Company, Bridgewater, N.J., U.S.A. The liquid permeable outer layer can be any suitable material and desirably one that provides a generally cloth-like texture and/or mating fastening component qualities. One example of such a material is a 20 gsm (grams per square meter) spunbond polypropylene nonwoven web. The outer layer may also be made of those materials of which liquid permeable bodyside liner 42 is made. While it is not a necessity for the outer layer to be liquid permeable, it is desired that it provides a relatively cloth-like texture to the wearer.

The inner layer of the outer cover 40 can be both liquid and vapor impermeable, or can be liquid impermeable and vapor permeable. The inner layer is desirably manufactured from a thin plastic film, although other flexible liquid impermeable materials may also be used. The inner layer, or the liquid impermeable outer cover 40 when a single layer, prevents waste material from wetting articles, such as bedsheets and clothing, as well as the wearer and care giver. A suitable liquid impermeable film for use as a liquid impermeable inner layer, or a single layer liquid impermeable outer cover 40, is a 0.2 millimeter polyethylene film commercially available from Huntsman Packaging of Newport News, Va., U.S.A. If the outer cover 40 is a single layer of material, it can be embossed and/or matte finished to provide a more cloth-like appearance. As earlier mentioned, the liquid impermeable material can permit vapors to escape from the interior of the disposable absorbent article, while still preventing liquids from passing through the outer cover 40. A suitable “breathable” material is composed of a microporous polymer film or a nonwoven fabric that has been coated or otherwise treated to impart a desired level of liquid impermeability. A suitable microporous film is a PMP-1 film material commercially available from Mitsui Toatsu Chemicals, Inc., Tokyo, Japan, or an XKO-8044 polyolefin film commercially available from 3M Company, Minneapolis, Minn.

The liquid permeable bodyside liner 42 may but need not have the same dimensions as the outer cover 40. The bodyside liner 42 is desirably compliant, soft feeling, and non-irritating to the child's skin. Further, the bodyside liner 42 can be less hydrophilic than the absorbent assembly, to present a relatively dry surface to the wearer and permit liquid to readily penetrate through its thickness.

The bodyside liner 42 can be manufactured from a wide selection of web materials, such as synthetic fibers (for example, polyester or polypropylene fibers), natural fibers (for example, wood or cotton fibers), a combination of natural and synthetic fibers, porous foams, reticulated foams, apertured plastic films, or the like. Various woven and nonwoven fabrics can be used for the bodyside liner 42. For example, the bodyside liner can be composed of a meltblown or spunbonded web of polyolefin fibers. The bodyside liner can also be a bonded-carded web composed of natural and/or synthetic fibers. The bodyside liner can be composed of a substantially hydrophobic material, and the hydrophobic material can, optionally, be treated with a surfactant or otherwise processed to impart a desired level of wettability and hydrophilicity. For example, the material can be surface treated with about 0.45 weight percent of a surfactant mixture including AHCOVEL® N-62 from Uniqema, Inc., a division of ICI of New Castle, Del., and GLUCOPON® 220UP from Cognis Corp. of Ambler, Pa., in an active ratio of 3:1. The surfactant can be applied by any conventional means, such as spraying, printing, brush coating or the like. The surfactant can be applied to the entire bodyside liner 42 or can be selectively applied to particular sections of the bodyside liner, such as the medial section along the longitudinal centerline.

A suitable liquid permeable bodyside liner 42 is a nonwoven bicomponent web having a basis weight of about 27 gsm. The nonwoven bicomponent can be a spunbond bicomponent web, or a bonded carded bicomponent web. Suitable bicomponent staple fibers include a polyethylene/polypropylene bicomponent fiber available from CHISSO Corporation, Osaka, Japan. In this particular bicomponent fiber, the polypropylene forms the core and the polyethylene forms the sheath of the fiber. Other fiber orientations are possible, such as multi-lobe, side-by-side, end-to-end, or the like. While the outer cover 40 and bodyside liner 42 can include elastomeric materials, it can be desirable in some embodiments for the composite structure to be generally inelastic, where the outer cover, the bodyside liner and the absorbent assembly include materials that are generally not elastomeric.

The absorbent assembly (not shown) is positioned between the outer cover 40 and the bodyside liner 42, which components can be joined together by any suitable means, such as adhesives, as is well known in the art. The absorbent assembly can be any structure which is generally compressible, conformable, non-irritating to the child's skin, and capable of absorbing and retaining liquids and certain body wastes. The absorbent assembly can be manufactured in a wide variety of sizes and shapes, and from a wide variety of liquid absorbent materials commonly used in the art. For example, the absorbent assembly can suitably include a matrix of hydrophilic fibers, such as a web of cellulosic fluff, mixed with particles of a high-absorbency material commonly known as superabsorbent material. High absorbency material can be provided in any form known in the art, including but not limited to particles, fibers, foams and films.

In a particular embodiment, the absorbent assembly includes a matrix of cellulosic fluff, such as wood pulp fluff, and superabsorbent hydrogel-forming particles. The wood pulp fluff can be exchanged with synthetic, polymeric, meltblown fibers or with a combination of meltblown fibers and natural fibers. The superabsorbent particles can be substantially homogeneously mixed with the hydrophilic fibers or can be nonuniformly mixed. The fluff and superabsorbent particles can also be selectively placed into desired zones of the absorbent assembly to better contain and absorb body exudates. The concentration of the superabsorbent particles can also vary through the thickness of the absorbent assembly. Alternatively, the absorbent assembly can include a laminate of fibrous webs and superabsorbent material or other suitable means of maintaining a superabsorbent material in a localized area.

Suitable superabsorbent materials can be selected from natural, synthetic, and modified natural polymers and materials. The superabsorbent materials can be inorganic materials, such as silica gels, or organic compounds, such as crosslinked polymers. Suitable superabsorbent materials are available from various commercial vendors, such as Dow Chemical Company located in Midland, Mich., U.S.A., and Stockhausen GmbH & Co. KG, D-47805 Krefeld, Federal Republic of Germany. Typically, a superabsorbent material is capable of absorbing at least about 15 times its weight in water, and desirably is capable of absorbing more than about 25 times its weight in water.

In one embodiment, the absorbent assembly is generally rectangular in shape, and includes a blend of wood pulp fluff and superabsorbent material. One preferred type of fluff is identified with the trade designation CR1654, available from U.S. Alliance, Childersburg, Ala., U.S.A., and is a bleached, highly absorbent sulfate wood pulp containing primarily soft wood fibers. As a general rule, the superabsorbent material is present in the absorbent assembly in an amount of from about 0 to about 90 weight percent based on total weight of the absorbent assembly. The absorbent assembly suitably has a density within the range of about 0.10 to about 0.50 grams per cubic centimeter. The absorbent assembly may or may not be wrapped or encompassed by a suitable tissue wrap that maintains the integrity and/or shape of the absorbent assembly.

The body portion 32 can also incorporate other materials that are designed primarily to receive, temporarily store, and/or transport liquid along the mutually facing surface with the absorbent assembly, thereby maximizing the absorbent capacity of the absorbent assembly. One suitable material is referred to as a surge layer (not shown) and includes a material having a basis weight of about 50 to about 120 grams per square meter, and including a through-air-bonded-carded web of a homogenous blend of 60 percent 3 denier type T-256 bicomponent fiber including a polyester core/polyethylene sheath and 40 percent 6 denier type T-295 polyester fiber, both commercially available from Kosa Corporation of Salisbury, N.C., U.S.A.

As noted previously, the side panels 34 are disposed on each side of the body portion 32. These transversely opposed side panels 34 can be permanently bonded to the front panel 35 and back panel 135 in the respective front and back regions 22, 24 along attachment lines 66, and can be releasably attachable between the front and back regions 22, 24. The side panels 34 may be permanently attached using attachment means known to those skilled in the art such as adhesive, thermal or ultrasonic bonding. As mentioned, the side panels 34 can also be formed as continuous extensions of the front and back panels 35, 135.

In particular embodiments for improved fit and appearance, the side panels 34 desirably have an average length dimension measured parallel to the longitudinal axis 48 that is about 20 percent or greater, and particularly about 25 percent or greater, of the overall length dimension of the absorbent article, also measured parallel to the longitudinal axis 48. For example, in training pants 20 having an overall length dimension of about 54 centimeters, the side panels 34 desirably have an average length dimension of about 10 centimeters or greater, such as about 15 centimeters. The longitudinal axis 48 and transverse axis 49 are shown in FIG. 1.

The side panels 34 desirably include an elastic material capable of stretching in a direction generally parallel to the transverse axis 49 of the training pant 20. Suitable elastic materials, as well as one described process of incorporating elastic side panels into a training pant, are described in the following U.S. Pat. Nos.: 4,940,464 issued Jul. 10, 1990 to Van Gompel et al.; 5,224,405 issued Jul. 6, 1993 to Pohjola; 5,104,116 issued Apr. 14, 1992 to Pohjola; and 5,046,272 issued Sep. 10, 1991 to Vogt et al.; all of which are incorporated herein by reference. In particular embodiments, the elastic material includes a stretch-thermal laminate (STL), a neck-bonded laminated (NBL), a reversibly necked laminate, or a stretch-bonded laminate (SBL) material. Methods of making such materials are well known to those skilled in the art and described in U.S. Pat. No. 4,663,220 issued May 5, 1987 to Wisneski et al.; U.S. Pat. No. 5,226,992 issued Jul. 13, 1993 to Morman; and European Patent Application No. EP 0 217 032 published on Apr. 8, 1987 in the names of Taylor et al.; all of which are incorporated herein by reference. Alternatively, the side panel material may include other woven or nonwoven materials, such as those described above as being suitable for the outer cover 40 or bodyside liner 42, or stretchable but inelastic materials.

In carrying out the method of the invention, the training pant 20 is suitably substantially pre-assembled, and if the side panels 34 are of the refastenable type, then the side panels 34 are suitably in a fastened position.

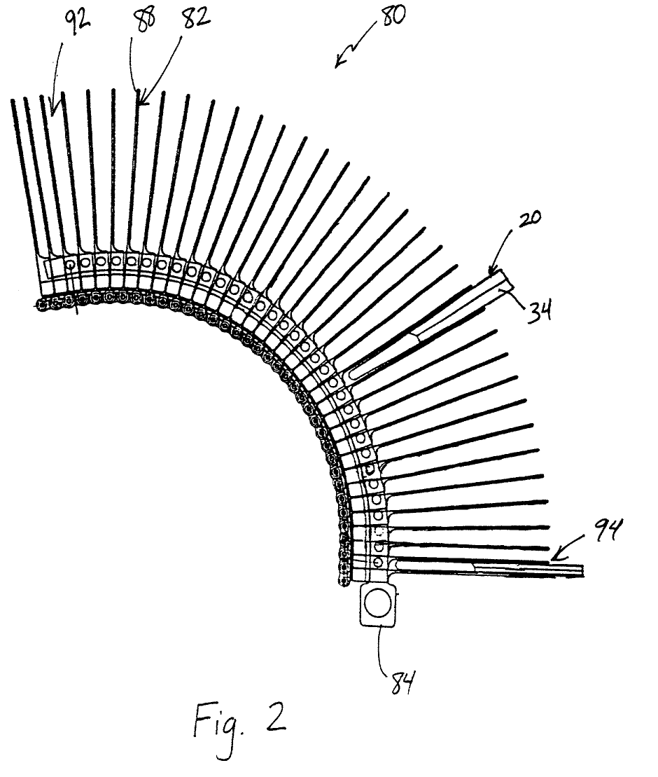

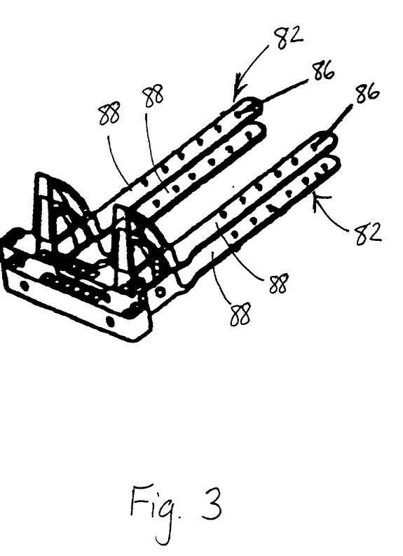

The method of the invention can be carried out using any suitable accumulation device. For ease of explanation, the description hereafter will be in terms of a method using a stacker assembly as an accumulation device. FIG. 2 shows a driven finger assembly type of stacker assembly 80 suitable for use in the present invention. The stacker assembly 80 includes a plurality of stacker finger units 82. A stacker finger unit 82 can be any device having at least one member against which a pant-like garment can be supported to mechanically open the garment. The stacker finger unit 82 may include two or more prongs 88, or “fingers,” as shown in FIG. 3, or may have any other suitable shape for supporting the garment. For example, the fingers 88 may be straight or curved, and may have any suitable cross-sectional shape, such as circular or rectangular, or may be a plate or a series of plates. Vacuum is delivered through a shoe 84 (or box) into an opening in each of the fingers 88. Each stacker finger unit 82 is chambered the full length of each finger 88 and is designed with openings 86 to deliver vacuum on both sides of the stacker finger unit 82. Vacuum levels vary greatly, depending on porosity of materials, rate of travel, and whether the fold location is to be controlled using high vacuum. Suitably, the vacuum levels may range up to about 30 inches of water, or between about 5 inches of water and about 20 inches of water.

FIG. 3 shows two consecutive stacker finger units 82 suitable for use in the present invention. As shown in FIG. 3, each stacker finger unit 82 may include two fingers 88. The consecutive stacker finger units 82 can move away from one another and back towards one another.

A training pant 20 is positioned between two consecutive stacker finger units 82 with the vacuum in the fingers 88 holding the front panel 35, the back panel 135, and/or the side panels 34 against the stacker finger units 82. The training pant 20 is carried through the stacker assembly 80 with the vacuum maintaining the pant in place against the fingers 88 of consecutive stacker finger units 82. While the pant 20 is held on both the front and back sides by the vacuum on consecutive stacker finger units 82, the pant is transferred to an area 92 where the consecutive stacker finger units 82 move apart from one another, thereby opening the pant.

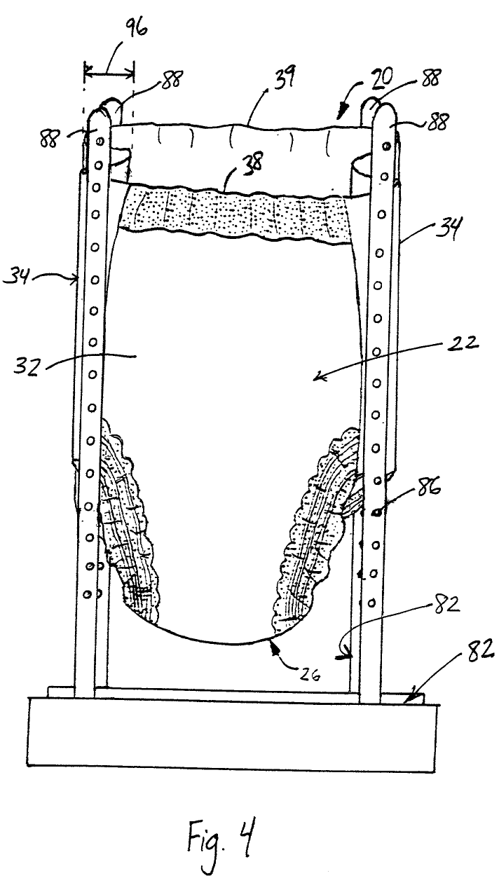

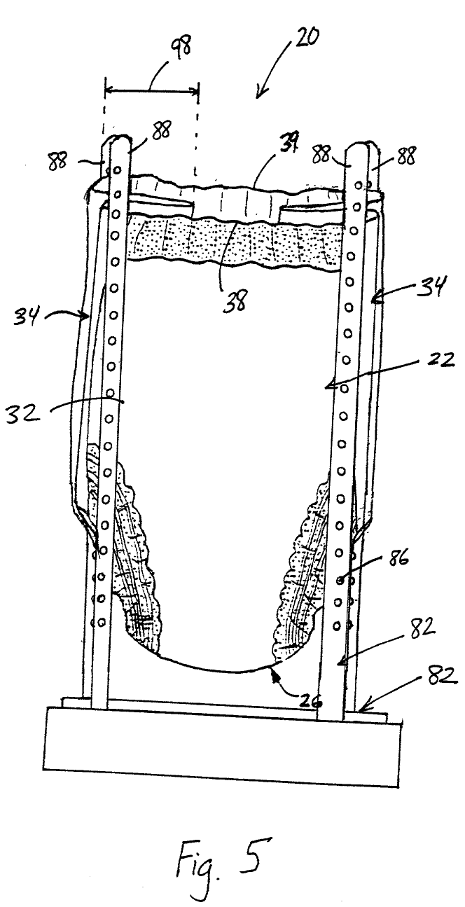

Once the pant 20 is open, the side panels 34 can be tucked, or at least partially tucked, into the body portion 32 of the pant using a tucking assembly, namely a mechanical device or fluid streams, such as air blasts or a vacuum, directed toward the side panels 34 to push the side panels 34 inward a certain distance toward one another. Suitable mechanical devices are described in detail below. The degree of tucking can be adjusted either by adjusting the mechanical device, adjusting the air blasts, and/or increasing or decreasing the distance between consecutive stacker finger units 82, thereby either increasing or decreasing the distance the side panels 34 are tucked. FIG. 4 shows the pant between two stacker finger units 82 in a partially tucked state. This embodiment is particularly suitable for swimpants or other garments having side panels 34 of a color that is different than the color of the outer cover 40 of the body portion 32, since this embodiment displays both the side panel color and the outer cover color at the same time. FIG. 5 shows the pant 20 between two stacker finger units 82 in a fully tucked state. Once the side panels 34 are tucked, the pant 20 is transferred to another stage 94 along the stacker assembly 80 in which consecutive stacker finger units 82 move back together, and the vacuum zone ends.

In an alternative embodiment of the invention, the tucking is carried out in two or more tucking steps, such that, for example, the side panels 34 are partially tucked a first distance 96 (FIG. 4) during the first tucking step and fully tucked a second distance 98 (FIG. 5) during the second tucking step, the second distance 98 being greater than the first distance 96. The term “filly tucked” indicates a degree of tucking desired in the finished product, and does not necessarily mean that the side panels 34 are tucked to the greatest extent possible. It may be desirable for portions of the side panels 34 to remain outside of the body portion 32, such as for pants wherein the front panel 35 is either narrower or wider in the transverse direction than the back panel 135. Any suitable tucking assembly can be used to carry out any of the tucking steps.

The multiple tucking embodiment of the present invention is useful, for example, when the pant 20 includes heat-activatable elastomeric material. While the pant 20 is in the open position between the stacker finger units 82, with the side panels 34 either partially tucked or not tucked, a sufficient amount of heat can be applied to the pant 20 to activate the elastomeric material. After the elastomeric material is activated, the pant 20 can then be fully tucked and the stacker finger units 82 moved back closer together.

The amount of pressure needed to tuck or partially tuck the side panels 34 is very much dependent on the material used to form the side panels 34. The fluid streams, or air blasts, when used to tuck or partially tuck the side panels 34, suitably exert a pressure of between about 5 pounds per square inch (psi) and about 100 psi on each side panel 34. Alternatively, the fluid streams may exert a force of between about 20 psi and about 60 psi, or between about 30 psi and about 50 psi.

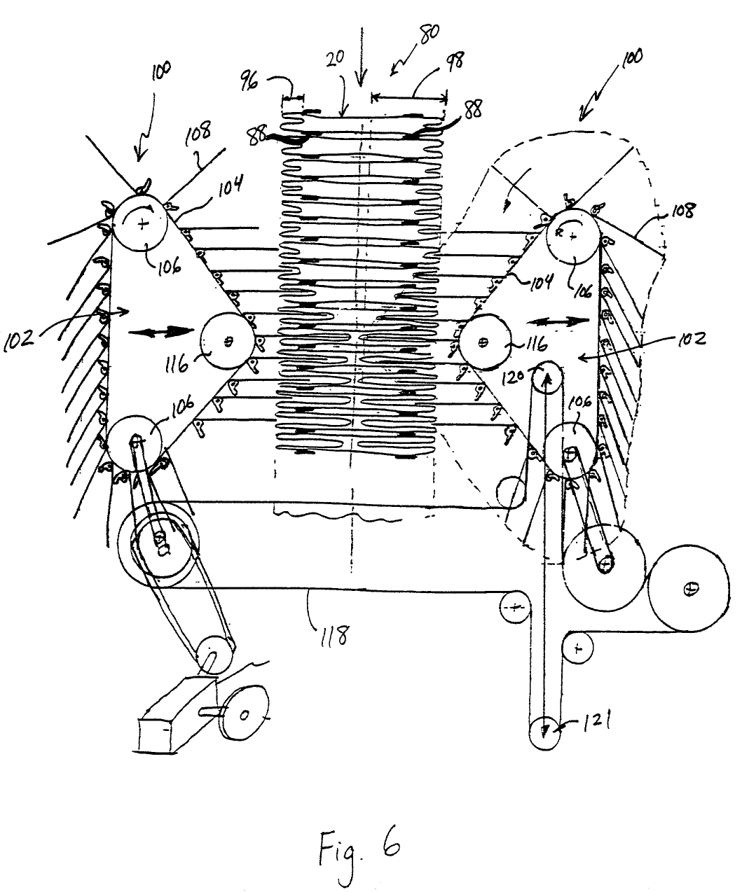

FIG. 6 illustrates one type of mechanical device suitable for tucking the side panels into the body portion of the pant. More specifically, FIG. 6 shows two opposing assemblies 100, each having a rotating device 102, such as a tucker assembly carrier 104 rotating about a set of sprockets 106, and a plurality of paddles 108 extending from the tucker assembly carrier 104. The two assemblies 100 rotate in opposite directions, such that they both move in the machine direction along with the stacker assembly 80.

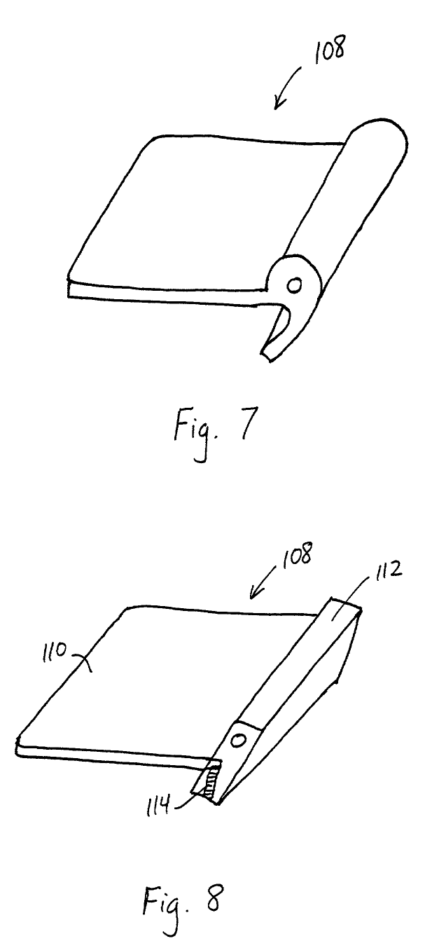

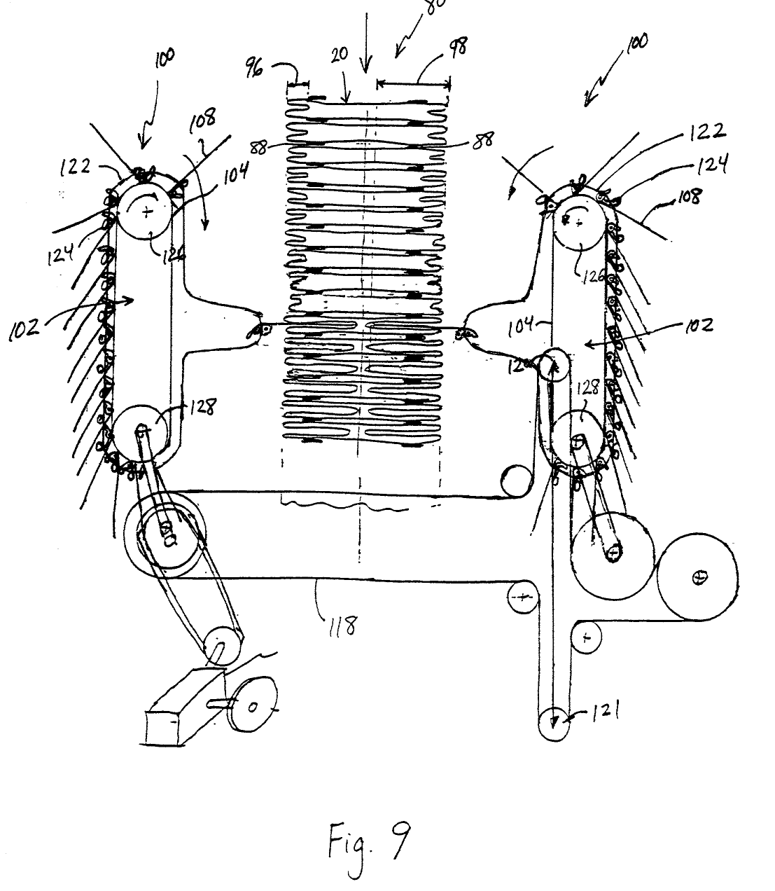

FIGS. 7 and 8 illustrate two types of suitable paddles 108 for use in the carrier and paddle mechanical device of FIG. 6. The paddle 108 shown in FIG. 7 can be made of glass-filled nylon. The paddle 108 shown in FIG. 6 can be made of a steel or aluminum portion 110 attached to a steel block 112 with set screws 114 set into the steel block 112.

In one embodiment, shown in FIG. 6, partially tucked training pants 20 are shown on the stacker assembly 80. In this embodiment, the training pants 20 are fully tucked by the paddles 108 as the rotating devices 102 move the paddles 108 in cooperation with the stacker assembly 80. More specifically, as the paddles 108 are rotated, a paddle 108 from each of the assemblies 100 is inserted into a training pant 20. As the paddles 108 move along with the stacker assembly 80, the paddles 108 push the side panels 34 inward toward one another. As the rotating devices 102 continue to rotate the paddles 108, the paddles 108 are pulled out of the pant 20 and drop. A middle sprocket 116 of each rotating device 102 can be adjusted by moving it back or forth as one way to adjust the degree of tucking. By moving the middle sprocket 116 closer to the stacker assembly 80, the tucking distance increases, and by moving the middle sprocket 116 away from the stacker assembly 80, the tucking distance is shallower. Alternatively, each of the assemblies 100 can be moved to alter the extent of tucking.

Drive means for the carrier and paddle mechanical device suitably may include a double-sided timing belt 118 which drives the rotating devices 102 on both sides of the stacker assembly 80. Upper and lower pulleys 120, 121 move as a pair.

With any of the traveling tucking arrays, such as paddles on carriers, the relative speed of travel of the paddles along a given axis, defined by the predominant direction of travel of the stacker assembly, must closely match the speed of travel of the stacker assembly units along that axis. In other words, the stacker finger units 82 define an overall direction of travel, and a rate of travel. The overall rate of travel of the paddles in that direction must closely match the rate of travel in that direction by the stacker assembly units, even if the paddles have components of motion that are not parallel to that direction, for example, even if the paddles shift from side to side, parallel to the direction of tucking, as they travel.

The effective spacing of tucking units, such as paddles, along the overall direction of travel of the stacker assembly units must also closely match the spacing of stacker assembly units in the tucking region of the stacker assembly, where the units may be spread apart somewhat from their neighbors. This tucking unit effective spacing is a function of the pitch of the tucking units along their carrier, wherein pitch refers to the spacing between units along the carrier, as well as a function of the angle at which the tucking carrier travels relative to the stacker assembly direction, and the relative velocities of tucker and stacker assembly carriers. The tucking units, such as paddles, must be registered to align with spaces between the stacker assembly units, i.e., stacker fingers, to avoid collisions or interference.

In another embodiment, rather than adjusting the degree of tucking by moving the middle sprockets 116 back and forth, a cam track 122, as shown in FIG. 9, can be used to guide the path of the carrier 104 and/or the paddles 108. The cam track 122 can extend and retract the tips of the paddles 108 to perform the tucking operation. As illustrated in FIG. 9, the paddles 108 can be equipped with cam followers 124 that manipulate the movement of the paddles 108 as the paddles 108 are circulated about the cam track 122 by the carrier 104, thereby moving the paddles in and out of the stacker so as to perform the tucking operation. Furthermore, in this design, the middle sprocket 116 is eliminated, leaving only an idler sprocket 126 and a drive sprocket 128. With this design, the tucker assembly carrier pitch determines the paddle effective linear velocity so the tucker assembly carrier 104 is the same pitch as the stacker assembly 80 and the effective linear velocity of the paddle 108 does not change as it tucks.

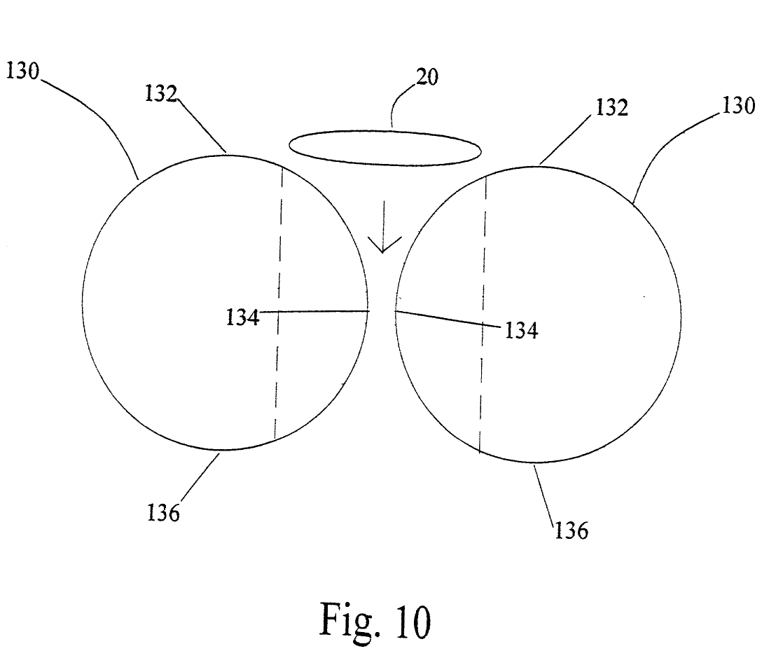

FIG. 10 illustrates another type of mechanical device suitable for tucking the side panels 34 into the body portion 32 of the pant 20. More specifically, FIG. 10 shows a path 130 of a blade tucker design. The potential advantage of the blade tucker is that the tucking can be done in a minimum amount of space. However, the small amount of space used means that the side panels 34 have to respond very rapidly with very little time to relieve stresses. Also, the effective linear velocity along the path of movement of the stacker assembly is constantly changing from zero at the top 132 of the blade tucker, to a maximum at 90 degrees at full tuck position 134, and back to zero at the bottom 136. To make the tucking blade match the speed of the stacker carrier requires a servo or non-circular gears. This may cause potential wear problems in that the paddle drive will be constantly accelerating and decelerating, thereby putting higher loads on all the bearings and pivot points compared to the carrier design that runs at a constant velocity.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

We claim:

1. A method of tucking a pair of opposing side panels into a body portion of a pant-like garment, the body portion including a front panel and a back panel, the method comprising the steps of:
positioning the body portion of the pant-like garment between two stacker finger units;
applying a vacuum through at least one finger on each of the stacker finger units to maintain the pant-like garment against the at least one finger;
increasing a distance between the two stacker finger units to pull the front panel of the pant-like garment away from the back panel of the pant-like garment;
pushing the opposing side panels into the body portion a distance toward one another; and
decreasing the distance between the two stacker finger units.

2. The method of claim 1, wherein a mechanical device is used to push the opposing side panels into the body portion.

3. The method of claim 2, wherein the mechanical device comprises two opposing assemblies, each assembly including a plurality of paddles attached to a rotating carrier.

4. The method of claim 3, wherein the mechanical device further comprises a cam track around which the carrier passes.

5. The method of claim 3, wherein the mechanical device further comprises a cam track around which the plurality of paddles passes.

6. The method of claim 2, wherein the mechanical device comprises a blade tucker.

7. The method of claim 2, wherein the distance the opposing side panels are pushed into the body portion toward one another is adjusted by adjusting the mechanical device.

8. The method of claim 1, wherein at least one fluid stream is used to push the opposing side panels into the body portion.

9. The method of claim 8, wherein the at least one fluid stream comprises a pair of opposing air blasts.

10. The method of claim 8, wherein the at least one fluid stream comprises a vacuum.

11. The method of claim 8, wherein the distance the opposing side panels are pushed into the body portion toward one another is adjusted by adjusting the at least one fluid stream.

12. The method of claim 1, wherein the distance the opposing side panels are pushed into the body portion toward one another is adjusted by adjusting the distance between the two stacker finger units.

13. The method of claim 1, further comprising the step of exposing the pant-like garment to a sufficient amount of heat to activate heat-activatable elastomeric material while the front panel of the pant-like garment is pulled away from the back panel of the pant-like garment.

14. A method of tucking a pair of opposing side panels into a body portion of a pant-like garment, the body portion including a front panel and a back panel, the method comprising the steps of:
positioning the body portion of the pant-like garment between two stacker finger units;
applying a vacuum through at least one finger on each of the stacker finger units to maintain the pant-like garment against the at least one finger;
increasing a distance between the two stacker finger units to pull the front panel of the pant-like garment away from the back panel of the pant-like garment;
pushing the opposing side panels into the body portion a first distance toward one another;
pushing the opposing side panels into the body portion a second distance toward one another, the second distance being greater than the first distance; and
decreasing the distance between the two stacker finger units.

15. The method of claim 14, wherein a mechanical device is used to push the opposing side panels into the body portion the first distance.

16. The method of claim 15, wherein the mechanical device comprises two opposing assemblies, each assembly including a plurality of paddles attached to a rotating carrier.

17. The method of claim 15, wherein the mechanical device comprises a blade tucker.

18. The method of claim 14, wherein a mechanical device is used to push the opposing side panels into the body portion the second distance.

19. The method of claim 18, wherein the mechanical device comprises two opposing assemblies, each assembly including a plurality of paddles attached to a rotating carrier.

20. The method of claim 18, wherein the mechanical device comprises a blade tucker.

21. The method of claim 14, wherein at least one fluid stream is used to push the opposing side panels into the body portion the first distance.

22. The method of claim 21, wherein the at least one fluid stream comprises a pair of opposing air blasts.

23. The method of claim 21, wherein the at least one fluid stream comprises a vacuum.

24. The method of claim 14, wherein at least one fluid stream is used to push the opposing side panels into the body portion the second distance.

25. The method of claim 24, wherein the at least one fluid stream comprises a pair of opposing air blasts.

26. The method of claim 24, wherein the at least one fluid stream comprises a vacuum.

27. The method of claim 14, further comprising the step of exposing the pant-like garment to a sufficient amount of heat to activate heat-activatable elastomeric material subsequent to pushing the opposing side panels into the body portion the first distance and prior to pushing the opposing side panels into the body portion the second distance.

28. Apparatus for tucking a pair of opposing side panels into a body portion of a pant-like garment, the apparatus comprising:
at least two consecutive stacker finger units, each stacker finger unit including at least one finger;
a vacuum delivered through the at least one finger on each of the stacker finger units; and
a tucking assembly.

29. The apparatus of claim 28, wherein the tucking assembly comprises two opposing assemblies, each assembly including a plurality of paddles attached to a rotating carrier.

30. The apparatus of claim 29, wherein the tucking assembly further comprises a cam track around which the carrier passes.

31. The apparatus of claim 29, wherein the tucking assembly further comprises a cam track around which the plurality of paddles passes.

32. The apparatus of claim 28, wherein the tucking assembly comprises a blade tucker.

33. The apparatus of claim 28, wherein the tucking assembly comprises at least one fluid stream.

34. The apparatus of claim 28, wherein the tucking assembly comprises a pair of opposing air blasts.

35. The apparatus of claim 28, wherein the tucking assembly comprises a vacuum.
